(19) United States
(12) Patent Application Publication
(10) Pub. No.: US 2023/0082654 A1
(43) Pub. Date: Mar. 16, 2023

(54) SYSTEM AND METHOD FOR INFERRING DRIVING CONSTRAINTS FROM DEMONSTRATIONS

(71) Applicants: Kasra REZAEE, Kitchener (CA); Peyman YADMELLAT, North York (CA)

(72) Inventors: Kasra REZAEE, Kitchener (CA); Peyman YADMELLAT, North York (CA)

(21) Appl. No.: 17/944,943

(22) Filed: Sep. 14, 2022

Related U.S. Application Data
(60) Provisional application No. 63/244,229, filed on Sep. 14, 2021.

(51) Int. Cl. B60W 60/00; G06N 3/08

(52) U.S. Cl. CPC B60W 60/001; G06N 3/084

(57) ABSTRACT

Systems, methods and computer-readable media for training a constraint model to indicate a validity of a planned activity, including training a distribution model and then training a constraint model by generating, using the constraint model, a respective constraint prediction for proposed activity samples; generating, using the trained distribution model, a respective distribution prediction for at least some of the proposed activity samples indicated by the constraint model as being valid proposed activity samples; adding, to a set of adversarial samples, the proposed activity samples that are indicated both by the constraint model as being valid proposed activity samples and by the distribution model as being as being out-of-distribution; and updating the constraint model based on the set of adversarial samples.

### RELATED APPLICATIONS

This application claims priority to and benefit of U.S. Provisional Patent Application Ser. No. 63/244,229, filed Sep. 14, 2021, the contents of which are incorporated herein by reference.

### FIELD

The present disclosure is related to systems, methods, and computer-readable media for motion planning, and in particular for inferring driving constraints from demonstrations.

### BACKGROUND

An autonomous vehicle (e.g. a self-driving car or other robotic machine) is a vehicle that includes different types of sensors to sense an environment surrounding the vehicle (e.g., the presence and state of stationary and dynamic objects that are in the vicinity of the vehicle) and operating parameters of the vehicle (e.g. vehicle speed, acceleration, pose, etc.) and is capable of operating itself safely without any human intervention. An autonomous vehicle typically includes various software systems for perception and prediction, localization and mapping, as well as for planning and control. The software system for planning (generally referred to as a planning system) plans a trajectory for the vehicle to follow based on target objectives, the vehicle's surrounding environment, and physical parameters of the vehicle (e.g. wheelbase, vehicle width, vehicle length, etc.). A software system for control of the vehicle (e.g. a vehicle control system) receives the trajectory from the planning system and generates control commands to control operation of the vehicle to follow the trajectory.

The planning system may include multiple planners (which may also be referred to as planning units, planning sub-systems, planning modules, etc.) arranged in a hierarchy. The planning system generally includes: a mission planner, a behavior planner, and a motion planner. The motion planner receives as input a behavior decision for the autonomous vehicle generated by the behavior planner as well as information about the vehicle state (including a sensed environmental data and vehicle operating data), and the road network the vehicle is travelling on and performs motion planning to generate a trajectory for the autonomous vehicle. In the present disclosure, a trajectory includes a sequence, over multiple time steps, of a position for the autonomous vehicle in a spatio-temporal coordinate system. Other parameters can be associated with the trajectory including vehicle orientation, vehicle velocity, vehicle acceleration, vehicle jerk or any combination thereof.

The motion planning system is configured to generate a trajectory that meets criteria such as safety, comfort and mobility within a spatio-temporal search space that corresponds to the vehicle state, the behavior decision, and the road network the vehicle is travelling on.

Planning in Autonomous Driving (AD) (or in general robotics) is the task of finding a sequence of decisions that will take the vehicle from its current state (for example current position) to a desired state (for example a target location). The planning problem can be generally defined as a constrained optimization problem:

$$\begin{matrix}min & f ( x ) & \\ subject to & {g}_{i} ( x ) = {c}_{i} & for i = 1 , … , n \\ & {h}_{j} ( x ) ≧ {d}_{j} & for j = 1 , … , m\end{matrix}$$

where x represents the vehicle's state, ƒ(x) is a cost function to be optimized, and gᵢ(x) and hⱼ(x) are the constraints to meet. ƒ(x) is often defined over a time period (aka planning time window or planning horizon interval), corresponding to the cost associated with executing a series of decisions within the planning time window. In autonomous driving, ƒ(x) is typically defined as a function of mobility, smoothness, and comfort level, where lower values of ƒ(x) indicates a higher level of comfort, smoothness, and mobility. The constraints, gᵢ(x) and hⱼ(x) represents the constraints associated with, but not limited to, vehicle dynamics and kinematics, safety considerations, driving rules, and planning continuity. An example of a safety consideration constraint is a requirement to maintain a minimum distance to other objects. An example of a driving rule constraint is a requirement to stop at stop signs. An example of planning continuity constraint is to ensure there is no discontinuity between two consecutive planning trajectories or to ensure there is no drastic jump in a vehicle's speed profile.

Although the planning problem is defined above as a minimization problem, it can be reformulated as a maximization problem, where the objective is to maximize an objective function (also referred to as reward function) to, for example, maximize comfort level and mobility.

In the context of behavior planning, the sequence of decisions is equivalent to a sequence of behavioral decisions, whereas in the context of motion planning, the sequence of decisions are represented by a motion planning trajectory consisting of a sequence of desired (time-stamped) vehicle states. These desired vehicle states can for example each include special coordinates indicating a desired vehicle position, acceleration values indicating desired vehicle linear and angular acceleration, velocity values indicating desired vehicle linear and angular velocity, and values indicating a vehicle pose, among other things. The objective in motion planning is then to find a trajectory that minimize a cost function subject to a set of constraints.

One of the main challenges is to find appropriate constraints for behaviour decisions and motion planning optimization problems. Some of the constraints, such as vehicle kinematics and dynamics related constraints, can be formulated with a high level of precision. It is also possible to define other constrains in simple and limited driving situations, but such solutions are not usually scalable or generalizable to more complex situations where there are any sorts of situation-dependency. For example, an autonomous vehicle may need to relax safety-related constraints to pass through a crowded environment, or ignore traffic rule constraints temporarily to go through a construction zone. Moreover, it is difficult to explicitly formulate some of the constraints as they are not quantifiable measures in nature. For example, comfort and safety are qualitative measures and defining them by equations is not straightforward.

A common approach to defining constraints is to have experts formulate the constraints based on their domain knowledge and/or based on historic driving data. While this approach is effective for some isolated cases, it becomes impractical when the formulated constraints need to remain valid in all possible driving situations.

A related challenge is defining a reward/cost function in Reinforcement Learning (RL) problems. Finding an appropriate reward/cost function for real-world problem is highly challenging in RL. Some approaches attempt to infer rewards from demonstrations. Effectively, a task is demonstrated by an expert and the movements/behaviors of the expert are measured and collected during the task demonstration. A reward function is then inferred to encourage the observed expert behavior. In literature this is commonly called Inverse Reinforcement Learning (IRL). IRL has been applied to various applications to infer rewards. For example, the document “Justin Fu, K. L. (2017). Learning Robust Rewards with Adversarial Inverse Reinforcement Learning. International Conference on Learning Representations” discloses a neural network being employed to learn a general reward function. Other approaches have been applied that try to specify a structure for the reward and fine tune certain parameters in the reward function (see for example the document “Zheng Wu, L. S. (2020). Efficient Sampling-Based Maximum Entropy Inverse Reinforcement Learning With Application to Autonomous Driving. 2020 International Conference on Robotics and Automation, (pp. 5355-5362).” Most IRL approaches assume that the optimization problem is a non-constraint problem and can be fully described by a reward/cost function.

There has been efforts to infer constraints from demonstrations (See for example the document: “Dexter R. R. Scobee, S. S. (2020). Maximum Likelihood Constraint Inference for Inverse Reinforcement Learning. 2020 International Conference on Learning Representations”. However, such a solution is computationally intensive and only applicable to discrete states and actions within a static environment.

It will thus be appreciated that constraints in robotics and AD are often hard to quantify by experts in complex scenarios. This is exacerbated when the robots need to operate in an environment where there are humans. An AD vehicle needs to drive so that the passengers and other human road participants (other drivers, cyclists, etc.) feel safe. While the driving behaviors of humans can be observed, the constraints a human driver considers when driving are unknown and thus difficult to quantify.

Accordingly, there is a need for effective systems and methods that enable constraints to be inferred from demonstrations.

### SUMMARY

According to a example aspects of the present disclosure are methods and computer-readable media for planning for an autonomous vehicle, comprising training a constraint model based on expert demonstration samples and adversarial samples.

According to a first example aspect of the disclosure is a method of training a constraint model to indicate a validity of a planned activity. The method includes: acquiring a plurality of demonstration samples, each demonstration sample including state data for one or more observed states of a respective activity demonstration; training, based on the acquired demonstration samples, a distribution model to generate a distribution prediction that indicates whether a sample activity input to the distribution model is either in-distribution of the plurality of demonstration samples or is out-of-distribution of the plurality of demonstration samples; and training the constraint model by (i) generating a plurality of proposed activity samples; (ii) generating, using the constraint model, a respective constraint prediction for at least some of the proposed activity samples, the constraint prediction indicating whether a proposed activity sample is either a valid proposed activity sample or is a constrained proposed activity sample; (iii) generating, using the trained distribution model, a respective distribution prediction for at least some of the proposed activity samples indicated by the constraint model as being valid proposed activity samples; (iv) adding, to a set of adversarial samples, the proposed activity samples that are indicated both by the constraint model as being valid proposed activity samples and by the distribution model as being as being out-of-distribution; and (v) updating the constraint model based on the set of adversarial samples.

In at least some examples of the first aspect, updating the constraint model is further based on a group of the demonstration samples.

In one or more of the preceding examples of the first aspect, the method includes iteratively repeating the training the constraint model until a defined training stop condition is achieved.

In one or more of the preceding examples of the first aspect, the planned activity comprises a proposed trajectory, and the trained constraint model is incorporated into a planning system of an autonomous vehicle, the method further comprising autonomously controlling a physical operation of the autonomous vehicle based on constraint predictions generated by the trained constraint model, and the demonstration samples are derived from real-life driving samples.

In one or more of the preceding examples of the first aspect, each of the demonstration samples comprises a time-series of state samples that each represent a respective state for a respective time-slot of the time-series, and generating the plurality of proposed activity samples comprises: generating, for each of at least some of the demonstration samples, a respective set of the proposed activity samples that are each based on at least one of the state samples of the demonstration sample; and combining the respective sets to form the plurality of proposed activity samples.

In one or more of the preceding examples of the first aspect, the state samples each comprise a multi-channel 2D state image.

In one or more of the preceding examples of the first aspect, the state samples each comprise a multi-dimensional vector.

In one or more of the preceding examples of the first aspect, each state sample indicates a time-slot state of an ego vehicle and its environment, and the demonstration samples each comprise a respective ego vehicle trajectory.

In one or more of the preceding examples of the first aspect, the generating, for each of at least some of the demonstration samples, the respective set of the proposed activity samples comprises: determining a sample trajectory between a first time-slot state sample and a final time-slot state samples of the demonstration sample.

In one or more of the preceding examples of the first aspect, generating the sample trajectory comprises randomly perturbing one or more state values to obtain intermediate state samples between the first time-slot state sample and the final time-slot state samples.

In one or more of the preceding examples of the first aspect, the distribution model comprises a neural-network based variational auto encoder that is trained to generate a reconstruction based on an input activity sample, the variational auto encoder comprising a set of convolution network layers that form an encoder.

In one or more of the preceding examples of the first aspect, the constraint model comprises the set of convolution network layers from the encoder followed by one or more fully connected neural network layers, wherein during the training of the constraint model parameters the fully connected neural network layers are updated without altering the set of convolution network layers.

According to a further example aspect, a system is disclosed for training a constraint model to indicate a validity of a planned activity, the system comprising one or more processor devices configured by instructions stored on one or more persistent storage mediums to perform the method of any of the preceding examples.

According to a further example aspect, a non-transient computer-readable medium is disclosed that stores instructions for execution by a processing unit for training a constraint model to indicate a validity of a planned activity, the instructions when executed causing the processing unit to perform the method of any of the preceding examples.

### BRIEF DESCRIPTION OF THE DRAWINGS

Reference will now be made, by way of example, to the accompanying drawings which show example embodiments of the present application, and in which:

FIG. 1 is a block diagram illustrating some components of an example autonomous vehicle.

FIG. 2 is block diagram illustrating some components of a processing system that may be used to implement a planning system of the autonomous vehicle of FIG. 8 according to example embodiments.

FIG. 3 is a block diagram illustrating further details of an example planning system.

FIGS. 4A to 4C illustrates a training example.

FIG. 5A illustrates an example of a training configuration for training a constraint model of a motion planner of the planning system of FIG. 3.

FIG. 5B is a flow diagram indicating a process of training the constraint model.

FIG. 6 is block diagram showing an example of a distribution model that can be used for the training configuration of FIG. 5A.

FIG. 7 is a block diagram showing an example of a constraint model.

FIG. 8 shows examples of state images that correspond to valid and constrained input samples.

FIG. 9A is a block diagram showing a further example of a constraint model.

FIG. 9B is a block diagram showing yet a further example of a constraint model.

Similar reference numerals may have been used in different figures to denote similar components.

### DESCRIPTION OF EXAMPLE EMBODIMENTS

Example aspects of this disclosure are directed towards a planning system and method that systematically infers activity constraints from real-life activity data. In a particular aspect, the activity is driving and example aspects of this disclosure are directed towards a planning system and method that systematically infers driving constraints from human driving data. The inferred constraints can be employed by a motion planner to find decisions that are within the bounds of humans driving and satisfy safety and driving rules. In the context of motion planning for autonomous driving (AD), the inferred constraints can be used to generate motion planning trajectories.

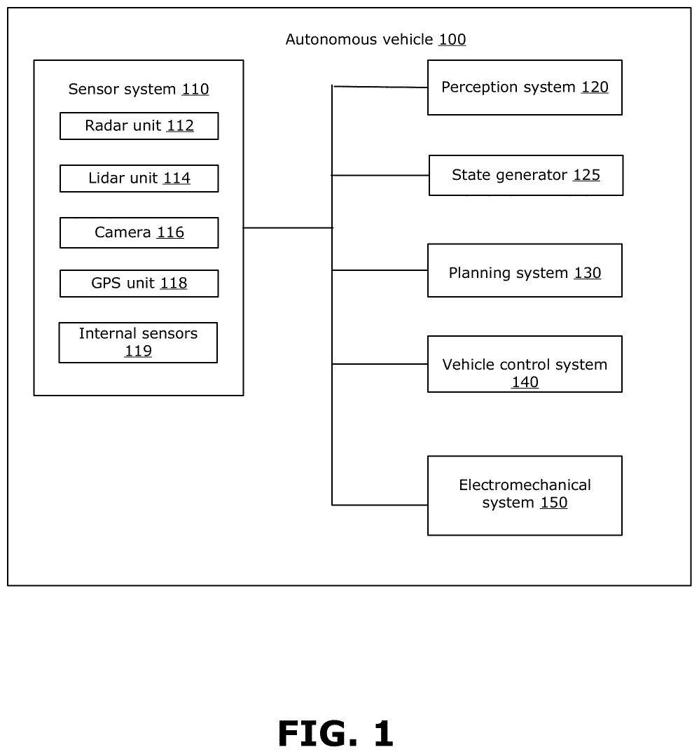

A brief description of an autonomous vehicle to which the example planning systems and method described herein can be applied will now be provided with reference to FIGS. 1, 2 and 3.

An autonomous vehicle typically includes various software systems for perception and prediction, localization and mapping, as well as for planning and control. The software system for planning (generally referred to as a planning system) plans a trajectory for the vehicle to follow based on target objectives and physical parameters of the vehicle (e.g. wheelbase, vehicle width, vehicle length, etc.). A software system for control of the vehicle (e.g. a vehicle control system) receives the trajectory from the planning system and generates control commands to control operation of the vehicle to follow the trajectory. Although examples described herein may refer to a car as the autonomous vehicle, the teachings of the present disclosure may be implemented in other forms of autonomous (including semi-autonomous) vehicles including, for example, trams, subways, trucks, buses, surface and submersible watercraft and ships, aircraft, drones (also referred to as unmanned aerial vehicles (UAVs)), warehouse equipment, manufacturing facility equipment, construction equipment, farm equipment, mobile robots such as vacuum cleaners and lawn mowers, and other robotic devices. Autonomous vehicles may include vehicles that do not carry passengers as well as vehicles that do carry passengers.

FIG. 1 is a block diagram illustrating certain components of an example autonomous vehicle 100 (hereafter referred to as vehicle 100 or ego vehicle 100). The vehicle 100 includes a sensor system 110, a perception system 120, a state generator 125, a planning system 130, a vehicle control system 140 and an electromechanical system 150, for example. The perception system 120, the planning system 130, and the vehicle control system 140 in this example are distinct software systems that include machine readable instructions that may, for example, be executed by one or more processors in a processing system of the vehicle 100. Various systems and components of the vehicle may communicate with each other, for example through wired or wireless communication.

The sensor system 110 includes various sensing units, such as a radar unit 112, a LIDAR unit 114, and a camera 116, for collecting information about an environment surrounding the vehicle 100 as the vehicle 100 operates in the environment. The sensor system 110 also includes a global positioning system (GPS) unit 118 for collecting information about a location of the vehicle in the environment. The sensor system 110 also includes one or more internal sensors 119 for collecting information about the physical operating conditions of the vehicle 100 itself, including for example sensors for sensing steering angle, linear speed, linear and angular acceleration, pose (pitch, yaw, roll), compass travel direction, vehicle vibration, throttle state, brake state, wheel traction, transmission gear ratio, cabin temperature and pressure, etc.

Information measured by each sensing unit of the sensor system 110 is provided as sensor data to the perception system 120. The perception system 120 processes the sensor data received from each sensing unit to generate data about the vehicle and data about the surrounding environment. Data about the vehicle includes, for example, one or more of: data representing a vehicle spatio-temporal position; data representing the physical attributes of the vehicle, such as width and length, mass, wheelbase, slip angle; and data about the motion of the vehicle, such as linear speed and acceleration, travel direction, angular acceleration, pose (e.g., pitch, yaw, roll), and vibration, and mechanical system operating parameters such as engine RPM, throttle position, brake position, and transmission gear ratio, etc.). Data about the surrounding environment may include, for example, information about detected stationary and moving objects around the vehicle 100, weather and temperature conditions, road conditions, road configuration and other information about the surrounding environment. For example, sensor data received from the radar, LIDAR and camera units 112, 114, 116 may be used to determine the local operating environment of the vehicle 100. Sensor data from GPS unit 118 and other sensors may be used to determine the vehicle's location, defining a geographic position of the vehicle 100. Sensor data from internal sensors 119, as well as from other sensor units, may be used to determine the vehicle's motion attributes, including speed and pose (i.e. orientation) of the vehicle 100 relative to a frame of reference.

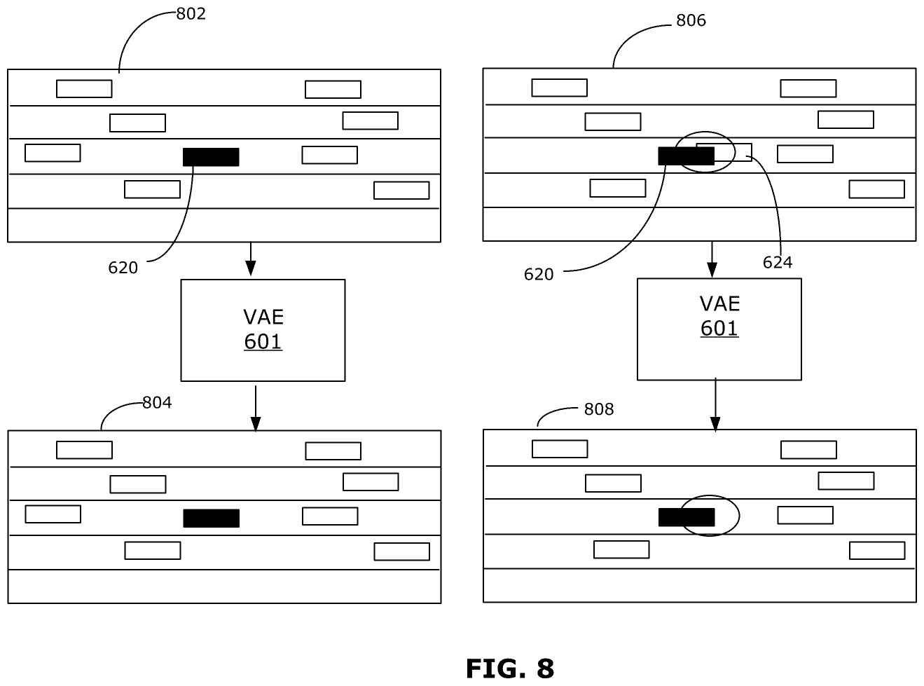

The data about the environment and the data about the vehicle 100 output by the perception system 120 is received by the state generator 125. The state generator 125 processes data about the environment and the data about the vehicle 100 to generate successive states for the vehicle 100 (hereinafter vehicle states) on an ongoing basis over a series of time steps. Although the state generator 125 is shown in FIG. 8 as a separate software system, in some embodiments, the state generator 125 may be included in the perception system 120 or in the planning system 130.

The vehicle states are output from the state generator 125 in real-time to the planning system 130, which generates a planning trajectory and is the focus of the current disclosure and will be described in greater detail below. The vehicle control system 140 serves to control operation of the vehicle 100 based on the planning trajectory output by the planning system 130. The vehicle control system 140 may be used to generate control signals for the electromechanical components of the vehicle 100 to control the motion of the vehicle 100. The electromechanical system 150 receives control signals from the vehicle control system 140 to operate the electromechanical components of the vehicle 100 such as an engine, transmission, steering system and braking system.

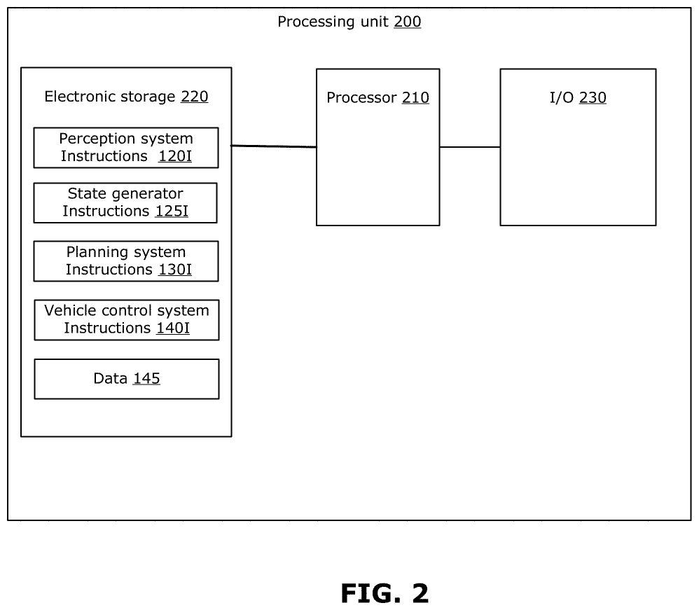

FIG. 2 illustrates an example of a processing system 200 that may be implemented in the vehicle 100. The processing system 200 includes one or more processors 210. The one or more processors 210 may include a central processing unit (CPU), a graphical processing unit (GPU), a tensor processing unit (TPU), a neural processing unit (NPU), a digital signal processor, and/or another computational element. The processor(s) 210 are coupled to an electronic storage(s) 220 and to one or more input and output (I/O) interfaces or devices 230 such as network interfaces, user output devices such as displays, user input devices such as touchscreens, and so on.

The electronic storage 220 may include any suitable volatile and/or non-volatile storage and retrieval device(s), including for example flash memory, random access memory (RAM), read only memory (ROM), hard disk, optical disc, subscriber identity module (SIM) card, memory stick, secure digital (SD) memory card, and other state storage devices. In the illustrated example, the electronic storage 220 of the processing system 200 stores instructions (executable by the processor(s) 210) for implementing the perception system 120 (instructions 1201), the state generator 125 (instructions 1251), the planning system 130 (instructions 1301), and the vehicle control system 140 (instructions 1401). In some embodiments, the electronic storage 220 also stores data 145, including sensor data provided by the sensor system 110, the data about the vehicle and the data about the environment output by the perception system 120 utilized by the planning system 130 to generate at least one of trajectories, and other data such as a road network map.

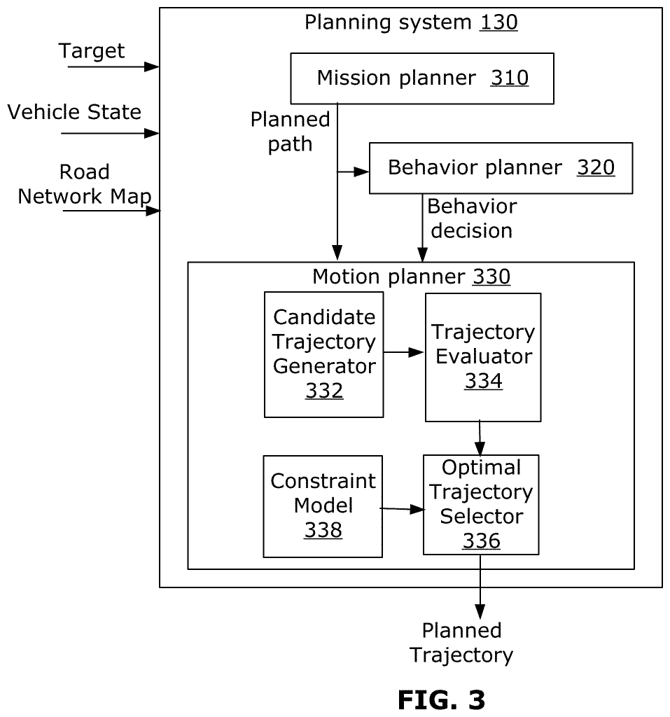

FIG. 3 is a block diagram that illustrates further details of the planning system 130.

The planning system 130 as shown can perform planning and decision making operations at different levels, for example at the mission level (e.g., mission planning performed by the mission planner 310), at the behavior level (e.g., behavior planning performed by the behavior planner 320) and at the motion level (e.g., motion planning performed by the motion planner 330). Mission planning is considered to be a higher (or more global) level of planning, motion planning is considered to be a lower (or more localized) level of planning, and behavior planning is considered to be a level between mission planning and motion planning. Generally, the output of planning and decision making operations at a higher level may form at least part of the input for a lower level of planning and decision making.

Generally, the purpose of planning and decision making operations is to determine a path (also referred to as a route) and corresponding trajectories for the vehicle 100 to travel from an initial position (e.g., the vehicle's current position and orientation, or an expected future position and orientation) to a target position (e.g., a final destination defined by the user). As known in the art, a path is a sequence of configurations in a particular order (e.g., a path includes an ordered set of spatial coordinates) without regard to the timing of these configurations, whereas a trajectory is concerned about when each part of the path must be attained, thus specifying timing (e.g., a trajectory is the path with time stamp data, and thus includes a set of spatio-temporal coordinates). In some examples, an overall path may be processed and executed as a set of trajectories. The planning system 130 determines the appropriate path and trajectories with consideration of conditions such as the drivable ground (e.g., defined roadway), obstacles (e.g., pedestrians and other vehicles), traffic regulations (e.g., obeying traffic signals) and user-defined preferences (e.g., avoidance of toll roads).

Planning and decision making operations performed by the planning system 130 may be dynamic, i.e. they may be repeatedly performed as the environment changes. Thus, for example, the planning system 130 may receive a new vehicle state output by the state generator 125 and repeat the planning and decision making operations to generate a new plan and new trajectories in response to changes in the environment as reflected in the new vehicle state. Changes in the environment may be due to movement of the vehicle 100 (e.g., vehicle 100 approaches a newly-detected obstacle) as well as due to the dynamic nature of the environment (e.g., moving pedestrians and other moving vehicles).

Planning and decision making operations performed at the mission level (e.g. mission planning performed by the mission planner 310) relate to planning a path for the vehicle 100 at a high, or global, level. The first position of the vehicle 100 may be the starting point of the journey and the target position of the vehicle 100 may be the final destination point. Mapping a route to travel through a set of roads is an example of mission planning. Generally, the final destination point, once set (e.g., by user input) is unchanging through the duration of the journey. Although the final destination point may be unchanging, the path planned by mission planning may change through the duration of the journey. For example, changing traffic conditions may require mission planning to dynamically update the planned path to avoid a congested road.

Input data received by the mission planner 310 for performing mission planning may include, for example, GPS data (e.g., to determine the starting point of the vehicle 100), geographical map data (e.g., road network from an internal or external map database), traffic data (e.g., from an external traffic condition monitoring system), the final destination point (e.g., defined as x- and y-coordinates, or defined as longitude and latitude coordinates), as well as any user-defined preferences (e.g., preference to avoid toll roads).

The planned path generated by mission planning performed by the mission planner 310 and output by the mission planner 310 defines the route to be travelled to reach the final destination point from the starting point. The output may include data defining a set of intermediate target positions (or waypoints) along the route.

The behavior planner 320 receives the planned path from the mission planner 310, including the set of intermediate target positions (if any). The behavior planner 320 also receives the vehicle state output by the state generator 125. The behavior planner 320 generates a behavior decision based on the planned path and the vehicle state, in order to control the behavior of the vehicle 100 on a more localized and short-term basis than the mission planner 310. The behavior decision may serve as a target or set of constraints for the motion planner 330. The behavior planner 320 may generate a behavior decision that is in accordance with certain rules or driving preferences. Such behavior rules may be based on traffic rules, as well as based on guidance for smooth and efficient driving (e.g., vehicle should take a faster lane if possible). The behavior decision output from the behavior planner 320 may serve as constraints on motion planning, for example.

The motion planner 330 is configured to iteratively find a trajectory to achieve the planned path in a manner that satisfies the behavior decision, and that navigates the environment encountered along the planned path in a relatively safe, comfortable, and speedy way.

In the example shown in FIG. 3, the motion planner 330 includes a candidate trajectory generator 332 that is configured to generate a set of candidate trajectories for a current planning horizon interval based, for example, on the planned path, road network map, and vehicle state. Candidate trajectory generator 332 can be implemented using known techniques including, for example, expert designed polynomial equations. Trajectory evaluator 334 is configured to compute costs for the candidate trajectories (for example mobility and comfort costs) and then sort the candidate trajectories accordingly. Optimal trajectory selector 336 is configured to select the best trajectory from the ranked list of candidate trajectories within the constraints provided by constraint model 338. The motion planner 330, including candidate trajectory generator 332, trajectory evaluator 334 and optimal trajectory selector 336, can be implemented using known techniques. However, constraint model 338 is trained using techniques that can improve the operation of motion planner 330, as will be described in greater detail below.

In example embodiments, the constraint model 338 is implemented using a machine learning based model (hereinafter “constraint model”) that is trained to classify input samples as constrained samples or unconstrained samples. In the case of an AD scenario, “constrained samples” can correspond to trajectories that include states that fall within unsafe regions (also referred as constrained regions) and “unconstrained samples” can correspond to trajectories that include only states that fall within safe regions (also referred as unconstrained regions. The constraint model may for example include a convolutional neural network. The training process starts with an initial constraint model (e.g., an untrained model) that is randomly initialized or initialized based on a pre-defined heuristic. The constraint model is trained using an iterative process. In this regard, the constraint model is trained using two sets of samples: expert demonstration samples that are supposed to be classified as unconstrained, and adversarial samples that are supposed to be classified as constrained. Expert demonstration samples may, for example, be obtained from known training datasets. During training, whenever the constraint model 338 classifies an expert demonstration sample as constrained, the constraint model will be trained to cause the expert demonstration sample to be classified as unconstrained.

Adversarial samples represent solutions to a planning optimization problem, subject to constraints provided by the constraint model, that are not similar to any of the expert demonstration samples. Effectively, the adversarial samples should not exist. Since they are a solution to the optimization problem given the current constraints, they are classified as unconstrained. During training, the constraint model needs to be updated to learn to classify adversarial samples as constrained. Through this learning process, a constraint space will expand to include constraints that correspond to the adversarial samples and shrink to exclude the expert demonstrations samples.

Thus, in example embodiments, the initialized, untrained constraint model can be considered an initial guess, which is then updated iteratively through the training process. In each iteration, a planning problem is solved based on the current constraint estimation (prior) to find an optimal solution. If the optimal solution includes any states that fall outside of the states that correspond to a demonstrated behavior distribution (i.e., outside of a distribution of the expert demonstration samples), those states (and the optimal solution) are marked as constrained and the constraint model is updated (posterior). The process is repeated until a pre-set threshold is met, where the optimal planning solution does not visit any out-of-distribution states.

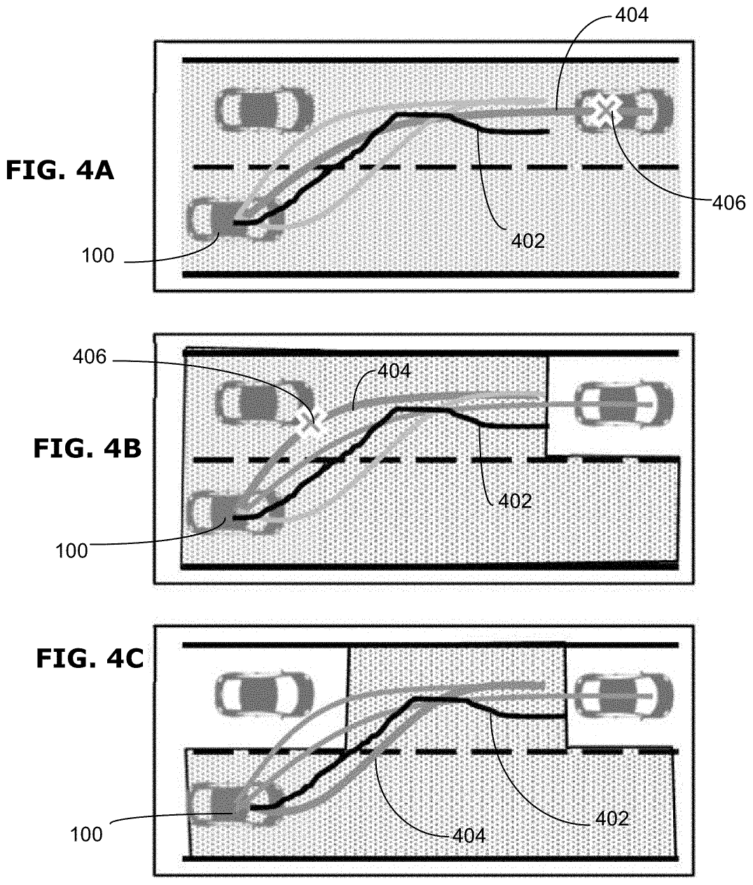

FIGS. 4A, 4B, and 4C show the progress of training for one single scene based on one single expert demonstration sample. The ego vehicle 100 has an initial position in the lower left of each Figure, and black line 402 labelled is the demonstrated trajectory (e.g., corresponds to an expert demonstration sample, driven by a human driver). The shaded road area depicts the valid (non-constrained) positions. White road areas are the constrained positions, which correspond to the spatio-temporal coordinates of vehicle states that have been classified as constrained. In FIG. 4A, the constraint model is initialized to consider all areas (e.g., all states) as non-constrained areas. Solving the planning optimization results in the trajectory 404. However, the trajectory 404 crosses some states (e.g., upper right corner, occupied by another vehicle) that were not visited by the human driver (black trajectory 402). The unvisited area 406 is marked with a red cross.

In FIG. 4B, the unvisited area 406 identified by a cross in FIG. 4A is marked as a constrained area, and the constraint model 338 is updated. If the optimization problem is solved with the current estimated constrained areas, the optimal trajectory 404 changes as shown in FIG. 4B. Again, the trajectory 404 crosses an area 406 that is far from the human driver trajectory 402. The constraint model is adjusted accordingly and the process is repeated. The result is shown in FIG. 4C, where the optimal trajectory 404 is close enough to the human driver trajectory 402. This can be considered as a threshold to terminate the iteration and return the constrained areas (constraint model).

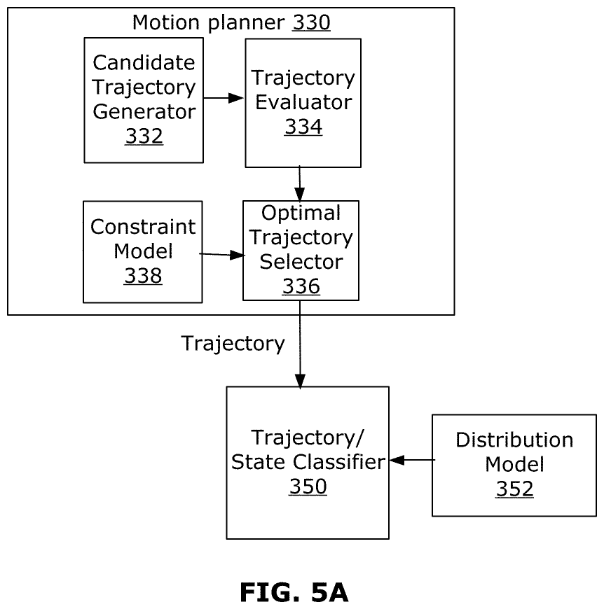

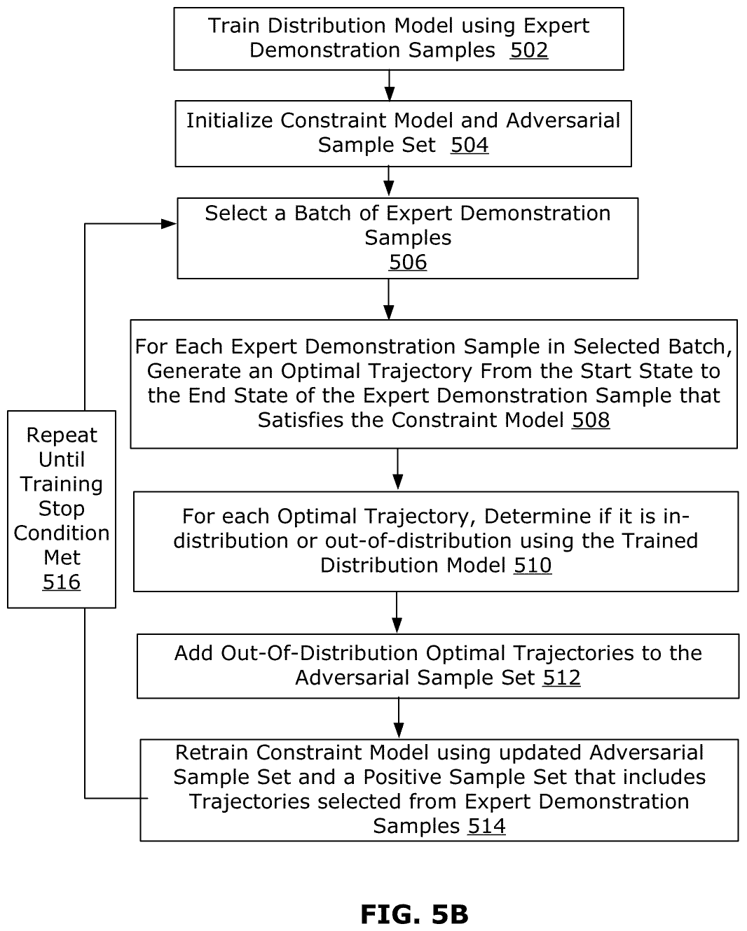

In this regard, FIG. 5A illustrates an example of a training configuration for training the constraint model 338 of motion planner 330, which includes a trajectory/state classifier 350 and a machine learning based distribution model 352.

Distribution model 352 is trained as part of a first training stage. Distribution model 352 is trained to generate an output that describes the distribution of the expert demonstration samples. Trajectory/State Classifier 350 is configured to receive a trajectory from motion planner 330 and then classify the states included within the trajectory as constrained or non-constrained states using the distribution model 352. It will be noted that optimal trajectory selects 336 an output trajectory from an input set of ranked trajectories based on classifications made by the constraint model 338. Thus, as a first training stage, distribution model 352 is trained to match the distribution of expert demonstrations samples to enable trajectory/state classifier 350 to classify a trajectory (i.e. sample) and states within the trajectory as being constrained (i.e., outside of the distribution of expert demonstration samples) or unconstrained.

A second training stage involves training the constraint model 338 (also referred to as learning a constraint function). In this second training stage, a known technique can be used to find the optimal trajectory solution for a given scenario that satisfy the constraint model 338. Then, the optimal trajectory is passed to trajectory/state classifier 350 to determine if the optimal trajectory is an out-of-distribution sample or not. If it is outside the demonstration distribution, the sample is labelled as constrained. The samples from expert demonstration samples are labeled as valid. The constraint model 338 will be trained to distinguish between these two classes of samples. As the constraint model 338 is trained and updated with these samples, it will affect the optimal solution, pushing it towards the expert demonstration samples. As the constraint function estimation converges, the optimal solution gets closer to the expert demonstration samples. The training process can be stopped once no new constrained samples are discovered.

With reference to FIG. 5B, the two stage training process can be summarized as follows: Stage 1:(1) Train a distribution model 352 to match the distribution of expert demonstration samples (Block 502); Stage 2: (2) Start with an initial random constraint model 338 and an empty set for adversarial samples (Block 504: Initialize Constraint Model and Adversarial Sample Set); (3) Gather a batch of expert demonstration samples (Block 506) and generate adversarial samples from each expert generation sample, by: 3(a) Find the optimal trajectory using a classic planning approach for the environment scene from the expert demonstration sample that satisfy the current constraint model 338 (Block 508: For Each Expert Demonstration Sample in Selected Batch, Generate an Optimal Trajectory From the Start State to the End State of the Expert Demonstration Sample that Satisfies the Constraint Model 338); 3(b) For each optimal trajectory, determine if the optimal trajectory/state is outside the expert demonstration sample distribution (Block 510: For each Optimal Trajectory, Determine if it is in-distribution or out-of-distribution using the Trained Distribution Model) (Block 512: Add out-of-distribution Optimal Trajectories to the Adversarial Sample Set), and if the Optimal trajectory optimal trajectory/state is within the expert demonstration sample distribution (i.e., valid), it can be discarded; (4) Take some samples from expert demonstration samples and some samples from adversarial samples set and update the constraint model 338 accordingly (Block 514: Retrain Constraint Model 338 using updated Adversarial Sample Set and a Positive Sample Set that includes Trajectory samples selected from Expert Demonstration Samples); (5) Repeat from step 3 (Block 516: Repeat blocks 506 to 514 until a predefined stop condition met).

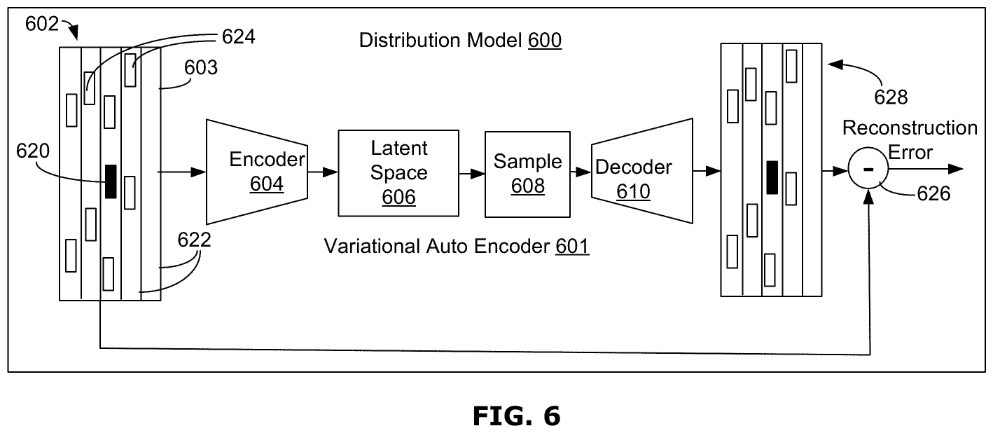

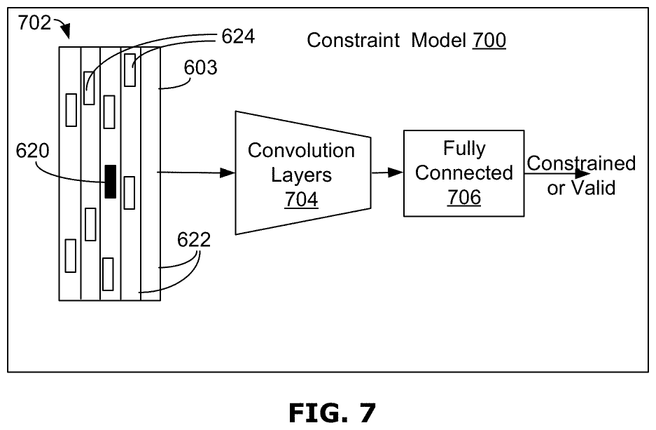

FIRST EXAMPLE EMBODIMENT: A first example application embodiment will now be described with reference to FIG. 6, which shows an example architecture for a distribution model 600 (which can be used to implement distribution model 352), FIG. 7, which shows an example architecture for a constraint model 700 (which can be used to implement constraint model 338) and FIG. 8, which shows images that are representative of inputs to and reconstructions by the distribution model 600. With reference to FIG. 6, in an example embodiment, an ego vehicle and environment state is represented with a multi-channel 2D state image 603, which may for example be a top-view image. Each pixel location in a channel of a multi-channel 2D state image stores a feature value. The respective channels describe various aspects of the environment, including: a channel with lane markings 622; a channel with box representing the ego vehicle 620; channels representing ego vehicle state (e.g., speed, acceleration, direction, steering angle, throttle, pose, etc.) and a channel with boxes representing other social vehicles 624. Further optional channels can include: a channel with direction-of-travel speed of each social vehicle along the lanes; a channel with lateral speed of each social object (speed perpendicular to the lane); and channels depicting the direction of lanes, among other things.

In some examples, coordinate-dependent features can be concatenating channels, containing hard-coded coordinates. An example of coordinate channels is presented in (Liu, 2018). Liu, R. L. (2018). An intriguing failing of convolutional neural networks and the coordconv solution. Retrieved from arXiv preprint arXiv:1807.03247.

In example embodiments, distribution model 600 can be implemented using a neural network. Other contextual information about state of the environment that are not location dependent can be injected to the distribution model 352 at vector layers (after convolution layers) of the neural network. These include information such as weather, lighting condition, urban/rural, desired comfort, etc.

In the illustrated embodiment distribution model 600 is implemented in the form of a Variation Auto-Encoder (VAE) for modelling the distribution of the demonstration samples. The VAE-based distribution model 600 will effectively learn to reproduce the input (e.g., an input sample 602 comprising a time-series of multi-channel state images 603) at the output (e.g., reconstruction 628, which is a reconstructed time-series of multi-channel state images). For a given input sample 602, if the input sample 602 and output reconstruction 628 are similar, the input sample 602 is considered to be from the distribution. If the reproduction (aka reconstruction 628) is different from the input sample 602, then the sample is an out-of-distribution sample.

With reference to FIG. 7, the constraint model 700 is represented by a set of convolution layers 704 followed by fully connected layers 706 working as a binary classifier. The block of convolution layers 704 is similar to an encoder block 604 of the VAE distribution model 352. This enables the encoder block 604 from the distribution model 600 to be reused for the convolution layers 704 of the constraint module 700 such that only the fully connected layers 706 of the constraint model 700 are updated during the training of the constraint model 700.

The constraint model 700 of FIG. 7 considers a trajectory (as represented by an input sample 702 comprising a time-series of multi-channel images that each represent an environment state within the trajectory) as input and identifies whether the trajectory is valid or not (constrained). The training of distribution model 600 and constraint model 700 are further detailed below through an example:

Step 1) Collect driving data for demonstration samples:

1a) Collect driving data for 10 different vehicles each driving for 1 minute with a time resolution of 0.1 seconds. The collected data for each 0.1 second time resolution corresponds to a respective multi-channel state image, and includes the position and state of the ego vehicle 620 and surrounding environment (including social vehicles 624 and environmental data included in other channels of the 2D state images).

1b) Break the driving data of each vehicle into 5 second intervals. Each interval will start from a whole second and intervals can overlap, i.e. the following intervals can be used for each vehicle: 0-5, 1-6, 2-7, 3-8, . . . , 55-60. Each of these sub-trajectories (also referred to as trajectory pieces) can be considered a demonstration. In the illustrated example, there are a total of 10×56 demonstrations.

1c) Each demonstration, which corresponds to a respective trajectory piece, is suitable for use as a respective input sample 602 (i.e., as a demonstration sample) for training the distribution model 600.

Step 2) Train distribution model 600 to fit to the distribution of the demonstration samples. Distribution model 600 will be trained on the demonstration samples obtained from real driving. The distribution model 600 is trained so that when the trained distribution model 600 is given a new sample, it will output a binary value determining whether the new sample is either: (a) similar to the demonstration samples used to train the distribution model 600 (i.e., determine whether new sample falls within the training distribution); or (b) not similar to the demonstration samples (outside the training distribution):

2a) The distribution model 600 is implemented using a Variational Auto-Encoder (VAE) 601, as indicated in FIG. 6. Known techniques can be used to train the VAE 601 to fit the distribution of the set of demonstration samples.

2b) The VAE 601 tries to reconstruct the input sample 602 at the output (e.g., reconstruction 628). The encoder block 604 encodes the input sample 602 to a smaller space (e.g., reduces the number of input values included in the input sample 602 by a few orders of magnitude) which is called latent space 606.

2c) The latent space 606 is encoded as a random variable (represented with mean and variance) rather than deterministic values (e.g., as inherent in the Variational aspect of “Variational Auto-Encoder”).

2d) Prior to decoding, an actual latent space is sampled 608 from the latent space 606 random variable. Then a decoder block 610 tries to reconstruct the input from the sampled latent space 606 (e.g., generate reconstruction 628)

2e) A comparison 626 is performed between the input sample 602 and the reconstruction 628 to compute a reconstruction error. The VAE 601 is trained so that the reconstruction error is minimized and the entropy of the latent space random variable is maximized.

2f) When the trained distribution model 600 is used for inference, a new sample is provided as input sample 602 to the VAE 601 of distribution model 600 and the resulting reconstruction 628 is observed (e.g., using caparison 626). If the reconstruction 628 is similar to the input sample 602 (e.g., meets a defined similarity criteria such as having a reconstruction error as determined by comparison 626 that falls within a defined threshold), the new sample is classified to be from the training data distribution. If the reconstruction 628 is different than input sample 602 (e.g., does not meet the defined similarity criteria) then the new sample is classified as being outside the training distribution.

By way of example, the left side of FIG. 8 represents an example of a state image 802 representing a first input sample that is processed by VAE 601 to generate a reconstructed image 804 representing a reconstruction of the first input sample. The right side of FIG. 8 represents an example of a further state image 806 representing a second input sample that is processed by VAE 601 to generate a reconstructed image 808 representing a reconstruction of the second input sample. In the case of state image 802, the ego vehicle 620 is following a trajectory that falls within the demonstration sample distribution that has been learned by the distribution model 600. Accordingly, the VAE 601 is able to generate a reconstruction (represented by reconstructed image 804) that is sufficiently similar to the first input sample to meet the predefined similarity metric. However, in the case of state image 806, the ego vehicle 620 overlaps with a social vehicle 624, and this is following a trajectory that does not fall within the demonstration sample distribution that has been learned by the distribution model 600. The VAE 601 is only able to generate reconstructions that fall within the demonstration sample distribution. Thus, the reconstruction (represented by reconstructed image 808) generated by VAE 601 is not sufficiently similar to meet the predefined similarity metric. In the example of FIG. 8, the first input sample would be classified by the distribution model 600 as “in distribution” and the second input sample would be classified as “out-of-distribution”.

Step 3) In this step, the constraint model 700 is learned. The constraint model 700 will take an input sample 702, and output a binary value whether the input sample 702 satisfies the driving constraints (the sample is valid) or it violates the driving constraints (the sample is constrained and should be avoided by the planner):

3a) The training starts with an empty set of constrained samples (also referred to as adversarial samples) and a blank constraint model. Effectively, the constraint model 700 is initialized so that for all input samples, its output reconstruction will be deemed valid.

3b) Generate M constrained samples. A constrained sample is the solution from a planning optimization process (e.g., a process that simulates motion planner 330) that satisfies the current constrain model 700, but should be in fact constrained. To do this, the following steps are applied for each of M randomly selected demonstration samples from all expert demonstration samples.

3b(i) Consider the first time-step in the sub-trajectory represented in the demonstration sample as initial point and extract the goal from the last time-step in the sub-trajectory

3b(ii) Use classic motion planning techniques and solve the optimization problem considering a cost function and constraints. The cost function is predefined to meet the comfort and mobility needs. The constraints are defined by the existing constraint model 700 (the model that is being learned, in this training step the existing constraint model 700 is used without being updated). For example: (i) Generate K random final points by perturbing the values from the sub-trajectory's last time-step. (ii) Generate a set of K trajectories with the sub-trajectory's start and previously generated final points. (iii) Calculate the cost for all generated trajectories and sort the trajectories according to their cost values; and (iv) Go through the generated trajectories in order and check if the trajectory satisfies the constraint model 700. Take the first trajectory (or highest ranked) that satisfies the constraint model 700 as a motion planning solution sample. If none of the generated trajectories satisfy the constraint model 700, skip to the next demonstration sample.

3b(ii) Use the trained distribution model 600 from step 2 and check if the motion planning solution sample is outside the demonstration sample distribution learned by the model or not. If the motion planning solution sample is outside the demonstration sample distribution, add the motion planning solution sample to the set of constrained samples. Otherwise skip to the next demonstration sample.

3c: Train the constraint model 600 for N steps: (i) Take a mini-batch with equal number of valid samples (samples from the demonstration samples from the collected driving data) and constrained samples (samples in the set of constrained samples added in previous step); (ii) Assign label 0 for valid samples and label 1 to constrained samples; (iii) Update the constraint model with backpropagation so that it can classify (distinguish between) the valid and constrained samples.

The above described first example application embodiment can be very flexible in some scenarios as multi-channel 2D images can be very expressive and can cover wide range of AD planning levels and scenarios. Also, various aspects of the road can be embedded in the 2D state images for the models 600, 700 to consider. Contextual information (weather, lighting, driver preference, etc.) can be also be easily integrated.

SECOND EXAMPLE EMBODIMENT: A second example application embodiment will now be described in which the input samples 602, 702 for distribution model 600 and constraint model 700 constitute single state images 603 rather than a trajectory (or portion of a trajectory) that comprises a time-series of state images 603. Thus, in the second example application embodiment, input samples 702, 602 for the constraint and distribution models 700, 600 represent a state corresponding to a single time-step rather than a trajectory (sequence of states over time). Similar to the above described first example embodiment, a demonstration is defined as a sub-trajectory of for a given period of time (for example 5 seconds). However, a sample is the ego vehicle state and the environment state for a single time step. The constraint model 700 and distribution model 600 take the input sample (i.e., the state for single time-step) as input and decide whether it is a constrained sample or a valid sample. An example of implementation of the second example embodiment is as follows:

Step 1) Collect driving data for demonstration samples:

1a) Collect driving data for 10 different vehicles each driving for 1 minute with a time resolution of 0.1 seconds. The collected data for each 0.1 second time resolution corresponds to a respective multi-channel state image, and includes the position and state of the ego vehicle 620 and surrounding environment (including social vehicles 624 and environmental data included in other channels of the 2D state images).

1b) Break the driving data of each vehicle into 5 second intervals. Each interval will start from a whole second and intervals can overlap, i.e. the following intervals can be used for each vehicle: 0-5, 1-6, 2-7, 3-8, . . . , 55-60. Each of these sub-trajectories corresponds to a demonstration. In the illustrated example, there are a total of 10×56 demonstrations.

1c) For each demonstration, which corresponds to a respective trajectory piece, a single state image is selected as a demonstration sample to represent the demonstration. In particular, in an illustrated example, the estate image that captures the ego and environment state for the first time step in a demonstration is used as the demonstration sample.

Step 2) Train distribution model 600 to fit to the distribution of the demonstration samples. Distribution model 600 will be trained on the demonstration samples obtained from real driving. The distribution model 600 is trained so that when the trained distribution model 600 is given a new sample, it will output a binary value determining whether the new sample is either: (a) similar to the demonstration samples used to train the distribution model 600 (i.e., determine whether new sample falls within the training distribution); or (b) not similar to the demonstration samples (outside the training distribution):

2a) The distribution model 600 is implemented using a Variational Auto-Encoder (VAE) 601, as indicated in FIG. 6. Known techniques can be used to train the VAE 601 to fit the distribution of the set of demonstration samples.

2b) The VAE 601 tries to reconstruct the input sample 602 at the output (e.g., reconstruction 628). The encoder block 604 encodes the input sample 602 to a smaller space (e.g., reduces the number of input values included in the input sample 602 by a few orders of magnitude) which is called latent space 606.

2c) The latent space 606 is encoded as a random variable (represented with mean and variance) rather deterministic values (e.g., as inherent in the Variational aspect of “Variational Auto-Encoder”).

2d) Prior to decoding, an actual latent space is sampled 608 from the latent space 606 random variable. Then a decoder block 610 tries to reconstruct the input from the sampled latent space 606 (e.g., generate reconstruction 628)

2e) A comparison 626 is performed between the input sample 602 and the reconstruction 628 to compute a reconstruction error. The VAE 601 is trained so that the reconstruction error is minimized and the entropy of the latent space random variable is maximized.

2f) When the trained distribution model 600 is used for inference, a new sample is provided as input sample 602 to the VAE 601 of distribution model 600 and the resulting reconstruction 628 is observed (e.g., using caparison 626). If the reconstruction 628 is similar to the input sample 602 (e.g., meets a defined similarity criteria such as having a reconstruction error as determined by comparison 626 that falls within a defined threshold), the new sample is classified to be from the training data distribution. If the reconstruction 628 is different than input sample 602 (e.g., does not meet the defined similarity criteria) then the new sample is classified as being outside the training distribution.

Step 3) In this step, the constraint model 700 is learned. The constraint model 700 will take an input sample 702, and output a binary value whether the input sample 702 satisfies the driving constraints (the sample is valid) or it violates the driving constraints (the sample is constrained and should be avoided by the planner):

3a) The training starts with an empty set of constrained samples (also referred to as adversarial samples) and a blank constraint model. Effectively, the constraint model 700 is initialized so that for all input samples, its output reconstruction will be deemed valid.

3b) Generate M constrained samples. A constrained sample is a state from the solution from a planning optimization process (e.g., a process that simulates motion planner 330) that satisfies the current constrain model 700, but should be in fact constrained. To do this, the following steps are applied for each of M randomly selected demonstration samples from all expert demonstration samples.

3b(i) Consider the first time-step in the sub-trajectory represented in the demonstration sample as initial point and extract the goal from the last time-step in the sub-trajectory

3b(ii) Use classic motion planning techniques and solve the optimization problem considering a cost function and constraints. The cost function is predefined to meet the comfort and mobility needs. The constraints are defined by the existing constraint model 700 (the model that is being learned, in this training step the existing constraint model 700 is used without being updated). For example: (i) Generate K random final points by perturbing the values from the sub-trajectory's last time-step. (ii) Generate a set of K trajectories with the sub-trajectory's start and previously generated final points. (iii) Calculate the cost for all generated trajectories and sort the trajectories according to their cost values; and (iv) Go through the generated trajectories in order and check if the trajectory satisfies the constraint model 700. For a trajectory to satisfy the constraint model, the states corresponding to each time-step of the trajectory must satisfy the constraint model 700. Take the first trajectory (or highest ranked) that satisfies the constraint model 700 as a motion planning solution sample. If none of the generated trajectories satisfy the constraint model 700, skip to the next demonstration sample.

3b(ii) Use the trained distribution model 600 from step 2 and check if the motion planning solution sample is outside the demonstration sample distribution learned by the model or not. If there is a state from the motion planning solution that is outside the demonstration sample distribution, add the state to the set of constrained samples. Otherwise skip to the next demonstration sample.

3c: Train the constraint model 600 for N steps: (i) Take a mini-batch with equal number of valid samples (samples from the demonstration samples from the collected driving data) and constrained samples (samples in the set of constrained samples added in previous step); (ii) Assign label 0 for valid samples and label 1 to constrained samples; (iii) Update the constraint model with backpropagation so that it can classify (distinguish between) the valid and constrained samples.

In the above-described second example embodiment, the states are being classified rather than a whole trajectory, and accordingly in some scenarios this embodiment will have better generalization compared to the first example embodiment and require less expert demonstration samples. Additionally, the second example embodiment can satisfy arbitrary trajectory length planning as compared to the first example embodiment where the length of trajectory is factored into the analysis.

THIRD EXAMPLE EMBODIMENT: In the first and second example embodiments, the ego vehicle and environment state (e.g., position, orientation, and speed of ego and surrounding vehicles/objects) is represented by multichannel 2D images. In a third example embodiment, multichannel 2D state images are replaced with vector representations. A state vector can contain respective elements indicating the position, speed, and orientation of a number of objects around the ego vehicle. For example, the position, speed, and orientation of 6 objects, corresponding to objects in front and back of the ego vehicle and the object on the three lanes in the immediate neighborhood of the ego vehicle. For cases where there is no object, the corresponding value will be filled with a default number.

According to the third example embodiment, state vectors can be used in place of state images in either of the first and second example embodiments described above. This approach can result in more compact models which may speed up the training process and result in shorter execution at inference time. Compared to the First and Second Embodiments, using a vector instead of 2D images can reduce model size and eliminate the need for computationally expensive convolution layers used to process image data.

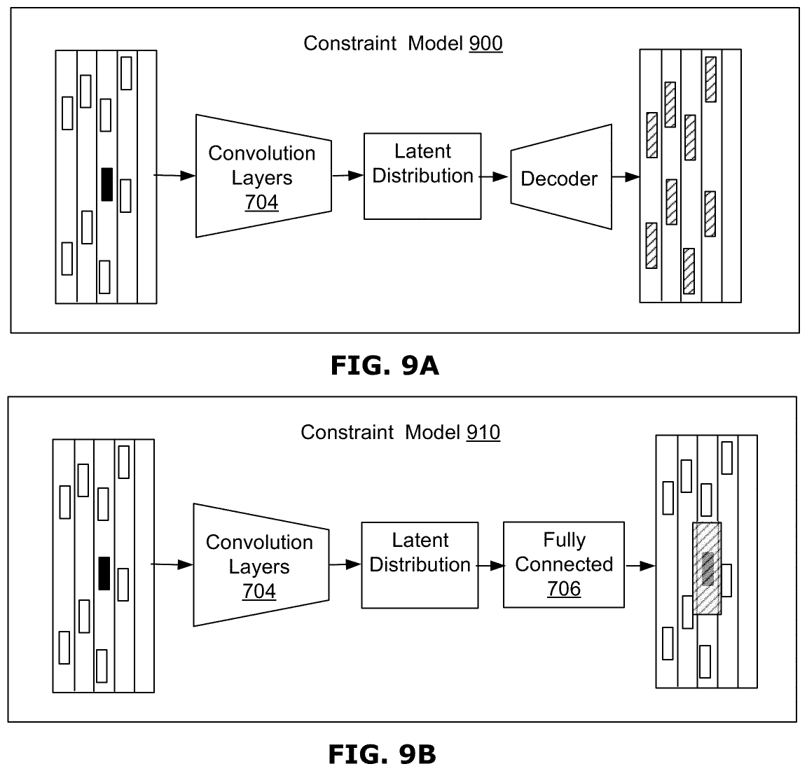

FOURTH EXAMPLE EMBODIMENT: In the first, second and third example embodiments, the output of the constraint model 700 is a binary value describing whether an input sample is constrained or valid. In a fourth example embodiment, a constraint model 900, 910 is extended to output the region around the ego that is valid (not constrained) for a given state. The output can be a 2D image showing the non-constrained region (see FIG. 9A), or a polygon around the ego vehicle showing the extent that the ego can deviate from its current position (see FIG. 9B). When training the constraint model 900, 910, the output of constraint model is expanded to include the valid samples. Similarly, the output of constraint model is contracted to exclude the constrained samples. The fourth example embodiment can be beneficial for an optimization algorithm that is using the constraint model. In previously described embodiments, an optimization algorithm tests each state to see if it is valid or not. However, in this fourth example embodiment, for a given state the range of states that are valid are given such that in at least some scenarios an optimization can be performed much faster.

Aspects are directed to a system and method to infer driving constraints from human driving demonstration. In some examples, inferring constraints is based on identifying whether a sample trajectory is an out-of-distribution sample.

In some examples, inferring constraints is based on the difference between an optimal solution and the human driving demonstrations.

In some examples, inferring constraints is done by learning the distribution of human driving trajectories and iteratively updating constraints by computing the probability of the optimal solution (trajectory) belonging to the learned human driving distribution.

In some example, a system and method is provided to infer constraints in dynamic environments by learning a mapping from current environment state to the constraints rather than finding fixed constraints for a given environment. Most existing algorithms focus on static environments, the proposed approach generalizes to dynamic environments with moving objects. In some examples, is a system and method to infer constraints for one or multiple specific types of driving scenarios by learning human driving data collected based on the specific scenario(s).

OTHER EXAMPLE EMBODIMENTS: While described for AD applications, the disclosed solutions are also applicable to any robotic problem where humans and robot interact in the same environment such as: warehouses with robots moving loads; assembly lines were robotic arms and humans working side-by-side; and service robots in airports, shopping malls, hospitals, etc. By observing the human behavior and developing constraints based on that, the behavior of robots when operating among humans would be more predictable and acceptable by humans, which also result in a higher level of safety.

Although examples have been described in the context of autonomous vehicles, it should be understood that the present disclosure is not limited to autonomous vehicles. For example, any vehicle that includes advanced driver-assistance system for a vehicle that includes a planning system may benefit from a motion planner that performs the trajectory generation, trajectory evaluation, trajectory selection operations of the present disclosure. Further, any vehicle that includes an automated driving system that can operate a vehicle fully autonomously or semi-autonomously may also benefit from a motion planner that performs the trajectory generation, trajectory evaluation, trajectory selection operations of the present disclosure. A planning system that includes the motion planner of the present disclosure may be useful for enabling a vehicle to navigate a structured or unstructured environment, with static and/or dynamic obstacles.

In this regard, a generalized example of applying the principles of one or more the above describe embodiments in the context an environment where the subject activity can be physical activity that is not restricted to driving will now be described. In particular, a method of training a constraint model (such as constraint model 700, 900, 920) to indicate a validity of a planned activity can include: (1) acquiring a plurality of demonstration samples, each demonstration sample including state data for one or more observed states of a respective activity demonstration; (2) training, based on the acquired demonstration samples, a distribution model (such as distribution model 600) to generate a distribution prediction that indicates whether a sample activity input to the distribution model is either in-distribution of the plurality of demonstration samples or is out-of-distribution of the plurality of demonstration samples; and (3) training the constraint model, comprising: (i) generating a plurality of proposed activity samples; (ii) generating, using the constraint model, a respective constraint prediction for at least some of the proposed activity samples, the constraint prediction indicating whether a proposed activity sample is either a valid proposed activity sample or is a constrained proposed activity sample; (iii) generating, using the trained distribution model, a respective distribution prediction for at least some of the proposed activity samples indicated by the constraint model as being valid proposed activity samples; (iv) adding, to a set of adversarial samples, the proposed activity samples that are indicated both by the constraint model as being valid proposed activity samples and by the distribution model as being as being out-of-distribution; and (v) updating the constraint model based on the set of adversarial samples. As disclosed above, updating the constraint model can be also based on a group of the demonstration samples, and the training the constraint model is repeated until a defined training stop condition is achieved.

In an AV use case, the demonstration samples are derived from real-life driving samples, the planned activity comprises a proposed trajectory, and the trained constraint model is incorporated into a planning system of an autonomous vehicle. The trained constraint model can be deployed as the constraint model 338 in a motion planner 330 and a physical operation of the autonomous vehicle controlled based on constraint predictions generated by the trained constraint model. Further, in the AV use case, each of the demonstration samples comprises a time-series of state samples that each represent a respective state for a respective time-slot of the time-series, and generating the plurality of proposed activity samples can include generating, for each of at least some of the demonstration samples, a respective set of the proposed activity samples that are each based on at least one of the state samples of the demonstration sample; and combining the respective sets to form the plurality of proposed activity samples. In some examples, the state samples each comprise a multi-channel 2D state image. In some examples, the state samples each comprise a multi-dimensional vector.

Although the present disclosure describes methods and processes with operations in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The contents of all published documents referenced in this disclosure are incorporated herein in their entirety.

1. A method of training a constraint model to indicate a validity of a planned activity, comprising:
acquiring a plurality of demonstration samples, each demonstration sample including state data for one or more observed states of a respective activity demonstration;
training, based on the acquired demonstration samples, a distribution model to generate a distribution prediction that indicates whether a sample activity input to the distribution model is either in-distribution of the plurality of demonstration samples or is out-of-distribution of the plurality of demonstration samples;
training the constraint model, comprising:
generating a plurality of proposed activity samples;
generating, using the constraint model, a respective constraint prediction for at least some of the proposed activity samples, the constraint prediction indicating whether a proposed activity sample is either a valid proposed activity sample or is a constrained proposed activity sample;
generating, using the trained distribution model, a respective distribution prediction for at least some of the proposed activity samples, the distribution prediction indicating whether a proposed activity sample is either in-distribution or is out-of-distribution;
adding, to a set of adversarial samples, the proposed activity samples that are indicated both by the constraint model as being valid proposed activity samples and by the distribution model as being out-of-distribution; and
updating the constraint model based on the set of adversarial samples and at least some of the demonstration samples.

2. The method of claim 1 comprising iteratively repeating the training the constraint model until a defined training stop condition is achieved.

3. The method of claim 1 wherein the planned activity comprises a proposed trajectory, and the trained constraint model is incorporated into a planning system of an autonomous vehicle, the method further comprising autonomously controlling a physical operation of the autonomous vehicle based on constraint predictions generated by the trained constraint model, and the demonstration samples are derived from real-life driving samples.

4. The method of claim 1 wherein each of the demonstration samples comprises a time-series of state samples that each represent a respective state for a respective time-slot of the time-series, and generating the plurality of proposed activity samples comprises:
generating, for each of at least some of the demonstration samples, a respective set of the proposed activity samples that are each based on at least one of the state samples of the demonstration sample; and
combining the respective sets to form the plurality of proposed activity samples.

5. The method of claim 4 wherein the state samples each comprise a multi-channel 2D state image.

6. The method of claim 4 wherein the state samples each comprise a multi-dimensional vector.

7. The method of claim 4 wherein each state sample indicates a time-slot state of an ego vehicle and its environment, and the demonstration samples each comprise a respective ego vehicle trajectory.

8. The method of claim 7 wherein the generating, for each of at least some of the demonstration samples, the respective set of the proposed activity samples comprises: determining a sample trajectory between a first time-slot state sample and a final time-slot state samples of the demonstration sample.

9. The method of claim 8 wherein generating the sample trajectory comprises randomly perturbing one or more state values to obtain intermediate state samples between the first time-slot state sample and the final time-slot state samples.

10. The method of claim 1 wherein the distribution model comprises a neural-network based variational auto encoder that is trained to generate a reconstruction based on an input activity sample, the variational auto encoder comprising a set of convolution network layers that form an encoder.

11. The method of claim 10 wherein the constraint model comprises the set of convolution network layers from the encoder followed by one or more fully connected neural network layers, wherein during the training of the constraint model parameters the fully connected neural network layers are updated without altering the set of convolution network layers.

12. A system for training a constraint model to indicate a validity of a planned activity, the system comprising one or more processor devices configured by instructions stored on one or more persistent storage mediums to perform a method comprising:
acquiring a plurality of demonstration samples, each demonstration sample including state data for one or more observed states of a respective activity demonstration;
training, based on the acquired demonstration samples, a distribution model to generate a distribution prediction that indicates whether a sample activity input to the distribution model is either in-distribution of the plurality of demonstration samples or is out-of-distribution of the plurality of demonstration samples;
training the constraint model, comprising:
generating a plurality of proposed activity samples;
generating, using the constraint model, a respective constraint prediction for at least some of the proposed activity samples, the constraint prediction indicating whether a proposed activity sample is either a valid proposed activity sample or is a constrained proposed activity sample;
generating, using the trained distribution model, a respective distribution prediction for at least some of the proposed activity sample, the distribution prediction indicating whether a proposed activity sample is either in-distribution or is out-of-distribution;
adding, to a set of adversarial samples, the proposed activity samples that are indicated both by the constraint model as being valid proposed activity samples and by the distribution model as being as being out-of-distribution; and
updating the constraint model based on the set of adversarial samples and at least some of the distribution samples.

13. The system of claim 12 wherein updating the constraint model is further based on a group of the demonstration samples and the training the constraint model is repeated until a defined training stop condition is achieved.

14. The system of claim 12 wherein the planned activity comprises a proposed trajectory, and the trained constraint model is incorporated into a planning system of an autonomous vehicle, the method further comprising autonomously controlling a physical operation of the autonomous vehicle based on constraint predictions generated by the trained constraint model, and the demonstration samples are derived from real-life driving samples.

15. The system of claim 14 wherein each of the demonstration samples comprises a time-series of state samples that each represent a respective state for a respective time-slot of the time-series, and generating the plurality of proposed activity samples comprises:
generating, for each of at least some of the demonstration samples, a respective set of the proposed activity samples that are each based on at least one of the state samples of the demonstration sample; and
combining the respective sets to form the plurality of proposed activity samples.

16. The system of claim 15 wherein the state samples each comprise a multi-channel 2D state image or a multi-dimensional vector.

17. The system of claim 15 wherein the generating, for each of at least some of the demonstration samples, the respective set of the proposed activity samples comprises: determining a sample trajectory between a first time-slot state sample and a final time-slot state samples of the demonstration sample.

18. The system of claim 17 wherein generating the sample trajectory comprises randomly perturbing one or more state values to obtain intermediate state samples between the first time-slot state sample and the final time-slot state samples.

19. The system of claim 12 wherein the distribution model comprises a neural-network based variational auto encoder that is trained to generate a reconstruction based on an input activity sample, the variational auto encoder comprising a set of convolution network layers that form an encoder, and the constraint model comprises the set of convolution network layers from the encoder followed by one or more fully connected neural network layers, wherein during the training of the constraint model parameters the fully connected neural network layers are updated without altering the set of convolution network layers.

20. A non-transient computer-readable medium storing instructions for execution by a processing unit for training a constraint model to indicate a validity of a planned activity, the instructions when executed causing the processing unit to perform the method of:
acquiring a plurality of demonstration samples, each demonstration sample including state data for one or more observed states of a respective activity demonstration;
training, based on the acquired demonstration samples, a distribution model to generate a distribution prediction that indicates whether a sample activity input to the distribution model is either in-distribution of the plurality of demonstration samples or is out-of-distribution of the plurality of demonstration samples;
training the constraint model, comprising:
generating a plurality of proposed activity samples;
generating, using the constraint model, a respective constraint prediction for at least some of the proposed activity samples, the constraint prediction indicating whether a proposed activity sample is either a valid proposed activity sample or is a constrained proposed activity sample;
generating, using the trained distribution model, a respective distribution prediction for at least some of the proposed activity samples, the distribution prediction indicating whether a proposed activity sample is either in-distribution or is out-of-distribution;
adding, to a set of adversarial samples, the proposed activity samples that are indicated both by the constraint model as being valid proposed activity samples and by the distribution model as being as being out-of-distribution; and
updating the constraint model based on the set of adversarial samples and at least some of the demonstration samples.
